(19) United States
(12) Patent Application Publication
(10) Pub. No.: US 2023/0155924 A1
(43) Pub. Date: May 18, 2023

(54) ROUTE SWITCHING METHOD, TRANSFER DEVICE, AND COMMUNICATION SYSTEM

(71) Applicant: NIPPON TELEGRAPH AND TELEPHONE CORPORATION, Tokyo (JP)

(72) Inventors: Keisuke YAMAGATA, Musashino-shi, Tokyo (JP); Kohei ASANO, Musashino-shi, Tokyo (JP); Shinichi YOSHIHARA, Musashino-shi, Tokyo (JP); Hideo KAWATA, Musashino-shi, Tokyo (JP)

(73) Assignee: NIPPON TELEGRAPH AND TELEPHONE CORPORATION, Tokyo (JP)

(21) Appl. No.: 17/916,654

(22) PCT Filed: Apr. 7, 2020
(86) PCT No.: PCT/JP2020/015599

§ 371 Date: Oct. 3, 2022

(51) Int. Cl. H04L 45/00; H04L 47/10; H04L 47/32

(52) U.S. Cl. CPC H04L 45/22; H04L 47/13; H04L 47/32

(57) ABSTRACT

An object is to provide a route switching method, a transfer device, and communication system that can continue communication even during route switching work. In a route switching method according to the present invention, in bypass transfer that transfers a packet while bypassing a non-transferable route, the transfer device having detected the non-transferable route attaches a bypass packet flag to the packet that passes through a non-transferable route and specifies the packet as a bypass packet, the transfer device having detected the non-transferable route returns the bypass packet and transfers the bypass packet in a direction opposite to that of the packet in the ring network, and the transfer device for which the blocked port is set in the ring network transfers the bypass packet through the blocked port before the route switching work.

### TECHNICAL FIELD

The present disclosure relates to a route switching method, a transfer device, and a communication system in a ring network.

### BACKGROUND ART

There is a communication system in which a communication route is formed in a ring shape and the communication route is made redundant by setting a blocked port in a transfer device (see, for example, PTL 1 and NPL 1).

### CITATION LIST

### Patent Literature

[PTL 1] Japanese Patent Application Publication No. 2009-189070

### Non Patent Literature

[NPL 1] JT-G8032 Ethernet Ring Protection Switching, Established Feb. 23, 2012

### SUMMARY OF THE INVENTION

### Technical Problem

FIG. 1 is a figure illustrating route switching work in a conventional ring network. In the conventional ring network, when a failure occurs in the ring network, the following operation is performed. It should be noted that a transporting device may be referred to as a “node” in this specification.

FIG. 1(A) is a figure illustrating a packet transfer route before route switching.

FIG. 1(B) is a figure illustrating the case in which a failure occurs in a link between nodes A and B. The nodes A and B detect the failure of the link.

FIG. 1(C) is a figure illustrating the operations of the nodes A and B after the detection of the failure. The nodes A and B block ports a2 and b1 connected to the failed link and transmit control packets for route switching from ports on the opposite side of the failed link.

FIG. 1(D) is a figure illustrating a packet transfer route after the route switching. After receiving the control packets, a node E releases the blocked ports (ring protection link end points) and performs switching the route of the packet from the side of a node F to the side of a node D.

The route switching work as illustrated in FIG. 1 takes time. That is, the conventional ring network has a problem in that, if a failure occurs in the ring network, communication cannot be easily continued during the process from the occurrence (detection) of the failure in FIG. 1(B) to the completion of the route switching in FIG. 1(D). In addition, even if route switching in the ring network is performed in a planned manner, there is a problem in that communication cannot be easily continued during the process from the route switching processing in FIG. 1(C) to the completion of the route switching in FIG. 1(D).

Accordingly, the present invention addresses the problems described above with an object of providing a route switching method, a transfer device, and a communication system that can continue communication even during route switching work.

### Means for Solving the Problem

In order to achieve the object described above, the route switching method according to the present invention causes a failure detection node to make a bypass determination of a normal packet in the ring when a failure occurs in the ring network so as to temporarily bypass the packet in parallel with the route switching processing.

Specifically, the route switching method according to the present invention is a route switching method in a ring network, the method including: detecting a non-transferable route through which packet transfer is disabled in the ring network; performing route switching work that changes a position of a blocked port set in a transfer device in the ring network and performs switching to a route that avoids the non-transferable route; and performing bypass transfer that transfers a packet while bypassing the non-transferable route during the route switching work, in which, in the bypass transfer, the transfer device having detected the non-transferable route attaches a bypass packet flag to a packet that passes through the non-transferable route and specifies the packet as a bypass packet, the transfer device having detected the non-transferable route returns the bypass packet and transfers the bypass packet in a direction opposite to that of the packet, and the transfer device for which the blocked port is set in the ring network transfers the bypass packet from the blocked port before the route switching work.

It should be noted that the blocked port is released after the route switching work, so the packet is transferred through a route that avoids the non-transferable route as a normal packet without being given the bypass packet flag.

In addition, a transfer device according to the present invention for achieving the route switching method is a transfer device included in a ring network, the transfer device, including: a detection unit that detects a non-transferable route through which packet transfer is disabled in the ring network; and a transfer control unit that performs route switching work for setting or releasing a blocked port by communicating with another transfer device in the ring network and performs switching a route of packet to a route that avoids the non-transferable route, in which the transfer control unit has a packet processing function that attaches a bypass packet flag to a packet that passes through the non-transferable route and specifies the packet as a bypass packet when the non-transferable route is detected, a turning function that turns the bypass packet in a direction opposite to that of the packet in the ring network, and a blocked port transfer function that transfers the bypass packet from the blocked port if the blocked port is set when the bypass packet is received before the route switching work.

FIG. 2 is a figure illustrating the route switching method.

FIG. 2(A) is a figure illustrating a packet transfer route before route switching.

FIG. 2(b) is a figure illustrating the case in which a failure occurs in the link between the nodes A and B. The node A detects a failure of the link.

FIG. 2(C) is a figure illustrating the operations of the nodes A and B after detection of the failure. The nodes A and B block ports a2 and b1 connected to the failed link and transmit control packets for route switching from ports on the opposite side of the failed link. Furthermore, the node A returns the packet transferred from a node F as a bypass packet. A node E transfers the bypass packet from the blocked port toward a node D. The transferred bypass packet is restored to the original packet at the node B and output to the outside of the ring network.

FIG. 2(D) is a figure illustrating the packet transfer route after the route switching. After receiving the control packets, the node E releases the blocked ports (ring protection link end points) and switches the route of packet from the side of the node F to the side of the node D. Since the packet does not reach the node A at this time, the node A terminates the turning of the packet.

By using the bypass packet, this route switching method can reduce the communication interruption time to the time (which depends on the transfer device) from the occurrence of a failure to the detection of the failure even if the failure occurs in the ring network. In addition, the route switching method can perform route switching without a communication interruption even when route switching in a ring network is performed in a planned manner. Accordingly, the present invention can provide the route switching method and the transfer device that can continue communication even during route switching work.

The route switching method attaches a blocked port pass flag that indicates whether to pass through the blocked port to the bypass packet. The route before passing through the blocked port is a turning section and, when the packet is output to the outside of the ring network, double transfer occurs. Accordingly, double transfer can be prevented by causing the packet to indicate “before passing through the blocked port” and “after passing through the blocked port”.

In this route switching method, the transfer device that transfers the packet to the outside of the ring network determines whether the packet is identical to a past packet and, when the packet is identical to the past packet, discards the packet.

When the packet is a multicast packet, both the normal packet and the bypass packet arrive depending on the node. Accordingly, double transfer can be prevented by checking the identity between the normal packet and the bypass packet and discarding one of these packets.

The communication system according to the present invention is a communication system for a ring network that includes the transfer device described above. Since this communication system includes the transfer device described above, the communication system can achieve the route switching method described above. Accordingly, the present invention can provide the communication system that can continue communication even during route switching work.

It should be noted that the inventions described above can be combined as much as possible.

### Effects of the Invention

The present invention can provide the route switching method, the transfer device, and the communication system that can continue communication even during route switching work.

### BRIEF DESCRIPTION OF DRAWINGS

FIG. 1 is a figure for describing a route switching method regarding the present invention.

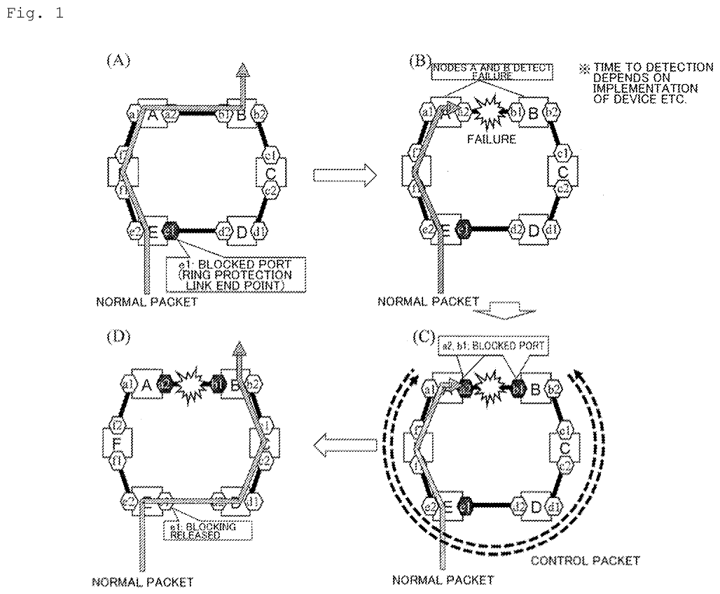

FIG. 2 is a figure for describing a route switching method according to the present invention.

FIG. 3 is a figure for describing a ring network.

FIG. 4 is a figure for describing the effect of a blocked port pass flag of the route switching method according to the present invention.

FIG. 5 is a figure for describing a transfer device according to the present invention.

FIG. 6 is a figure for describing the route switching method according to the present invention.

FIG. 7 is a figure for describing the route switching method according to the present invention.

FIG. 8 is a figure for describing the route switching method according to the present invention.

FIG. 9 is a table summarizing the operations of the transfer device according to the present invention.

FIG. 10 is a figure for describing a problem of the present invention.

FIG. 11 is a figure for describing the transfer device according to the present invention.

FIG. 12 is a figure for describing the route switching method according to the present invention.

FIG. 13 is a figure for describing the route switching method according to the present invention.

FIG. 14 is a figure for describing the transfer device according to the present invention.

FIG. 15 is a figure for describing the route switching method according to the present invention.

FIG. 16 is a figure for describing the route switching method according to the present invention.

### DESCRIPTION OF EMBODIMENTS

Embodiments of the present invention will be described with reference to the attached drawings. The embodiments described below are examples of the present invention and the present invention is not limited to the following embodiments. It should be noted that components having the same reference numeral in this specification and the drawings are assumed to be identical to each other.

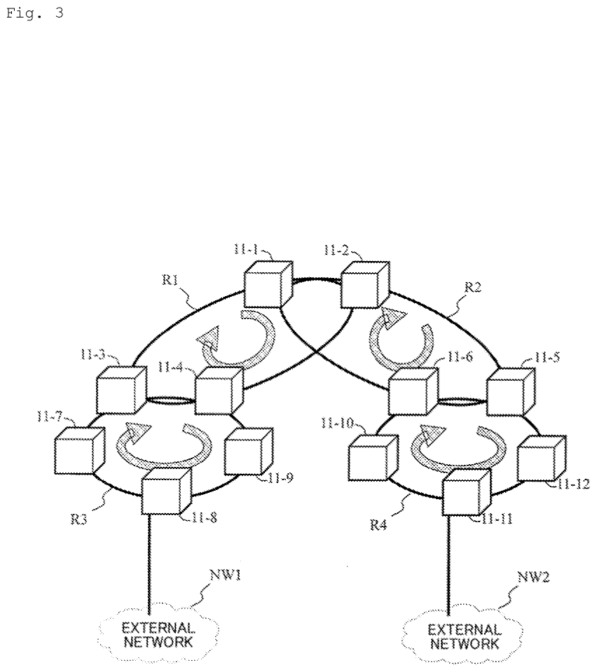

FIG. 3 is a figure for describing a ring network. One ring network includes a plurality of transfer devices 11 connected in a ring shape. For example, transfer devices (11-1 to 11-4) constitute one ring network R1. In addition, the transfer devices may be shared with another ring network. For example, the transfer device 11-3 is shared between the ring network R1 and a ring network R3. In addition, the transfer devices are also connected to a network outside the ring networks. For example, a transfer device 11-8 is also connected to an external network NW1. In the structure example illustrated in FIG. 3, the packet from the external network NW1 enters the ring network R3 via the transfer device 11-8, transferred to the ring network R1, the ring network R2, and the ring network R4 in this order, and output to an external network NW2 through a transfer device 11-11.

### Embodiment 1

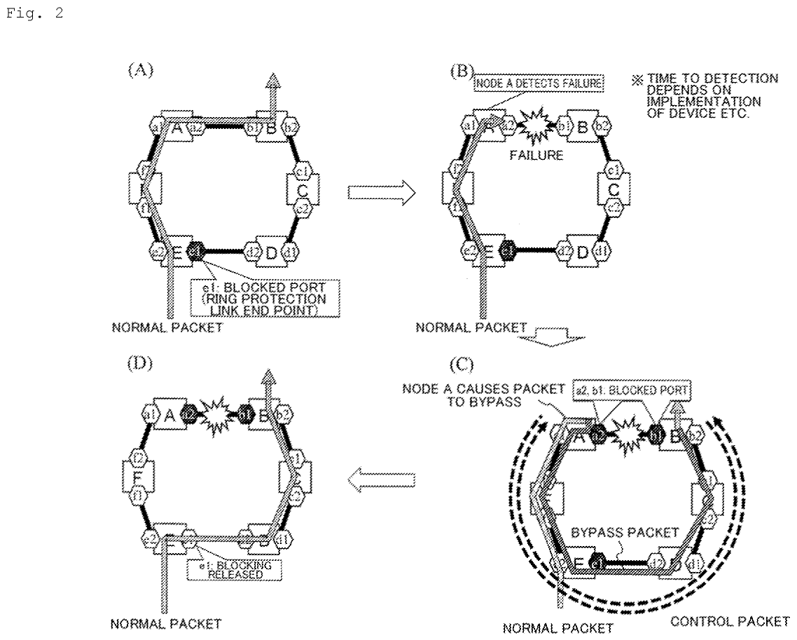

In the embodiment, description is given focusing on one ring network. FIG. 2 is a figure for describing the route switching method in one ring network that the embodiment focuses on.

The route switching method include: detecting a non-transferable route (link directly connecting the node A and node B to each other) through which packet transfer is disabled in the ring network (FIG. 2(B)); performing route switching work that changes (from a port e1 to ports (a2 and b1)) the position of a blocked port set in a transfer device in the ring network and performs switching to a route that avoids the non-transferable route; and performing bypass transfer that transfers a packet while bypassing the non-transferable route during the route switching work (FIG. 2(C)).

It should be noted that the non-transferable route may be caused by a failure or a planned route switching work.

In the bypass transfer in FIG. 2(C), the transfer device (node A) having detected the non-transferable route attaches a bypass packet flag to the packet that passes through the non-transferable route and specifies the packet as a bypass packet, the transfer device having detected the non-transferable route returns the bypass packet and transfers the bypass packet in a direction opposite to that of the packet in the ring network, and the transfer device for which the blocked port e1 is set in the ring network transfers the bypass packet through the blocked port e1 before the route switching work.

It should be noted that, since the blocking of the port e1 is released as illustrated in FIG. 2(D) after the route switching work, the packet is transferred as a normal packet in a route (the order of E, D, C, and B) that avoids the non-transferable route without being given a bypass packet flag.

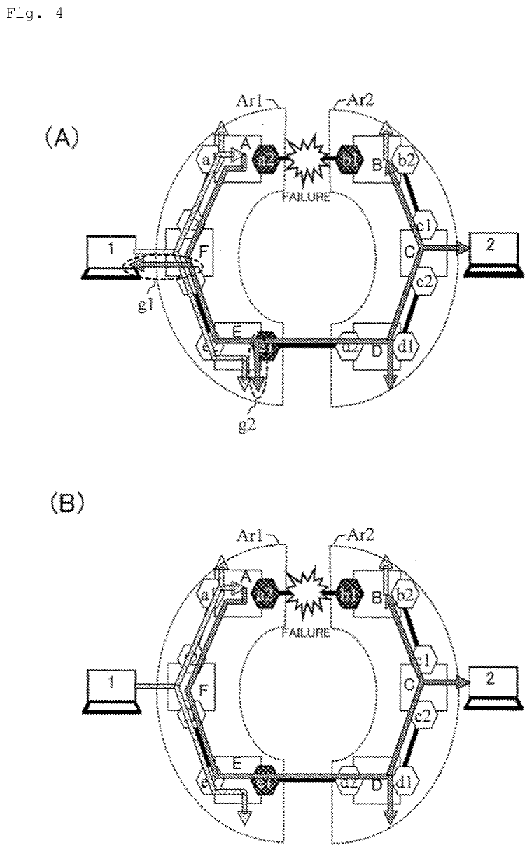

When transfer by the transfer device is flooding, a blocked port pass flag indicating whether to pass through the blocked port is preferably attached to the bypass packet. FIG. 4 is a figure for describing the effect of the blocked port pass flag. FIG. 4(A) is a figure illustrating the transfer of the bypass packet when the blocked port pass flag is not present and FIG. 4(B) is a figure illustrating the transfer of the bypass packet when the blocked port pass flag is present.

First, the case in which the blocked port pass flag in FIG. 4(A) is not present will be described. It is assumed that a packet is input to the node F from a terminal 1. The node F transfers the packet to the node A and the node E. The node A transfers the packet to the outside of the ring and turns the packet (transfers the packet to the node F) as a bypass packet because a port a2 is blocked. The node F transfers the bypass packet to the node E and also outputs the bypass packet to the terminal 1, which is the transmission source (symbol g1). Furthermore, the node E transfers both the packet transferred from the node F and the bypass packet to the outside of the ring (symbol g2). That is, double transfer occurs at the node E.

In addition, the node E transfers the bypass packet from the blocked port e1 to the node D. The bypass packet is transferred to the node D, the node C, and the node B in this order, restored to the original packet in these nodes, and transferred to the outside of the ring. In other words, in an area Ar2 (area including the nodes B, C, and D) in which the bypass packet exceeds the blocked port e1, the packet from terminal 1 can be output even if the link between the node A and the node B fails, and the terminal 2 can receive the packet.

In contrast, in an area An (area including the nodes A, F, and E) in which the bypass packet does not exceed the blocked port e1, double transfer of the packet occurs as indicated by the symbols g1 and g2.

The blocked port pass flag is used to prevent this double transfer of the packet in the embodiment. The individual nodes determine whether the bypass packet is output to the outside of the ring by checking the value of the blocked port pass flag. For example, the individual nodes determine that the bypass packet is not output to the outside of the ring when the blocked port pass flag is “0” or the bypass packet is output to the outside of the ring when the blocked port pass flag is “1”.

A specific example will be described with reference to FIG. 4(B). As in the case in FIG. 4(A), the node A receives the packet from the terminal 1 transferred by the node F. Then, the node A transfers the packet to the outside of the ring and returns the packet (transfers the packet to the node F) as the bypass packet because the port a2 is blocked. At this time, the node A attaches the blocked port pass flag “0” to the bypass packet. The nodes F and E do not output the bypass packet to the outside of the ring because the blocked port pass flag of the packet is “0”. Accordingly, double transfer of the packet can be prevented in the area Ar1.

In addition, the node E changes the blocked port pass flag from “0” to “1” when transferring the bypass packet from the blocked port e1. Accordingly, the nodes (B, C, and D) in the area Ar2 can output the bypass packet and the terminal 2 can receive the packet as in the case in FIG. 4(A).

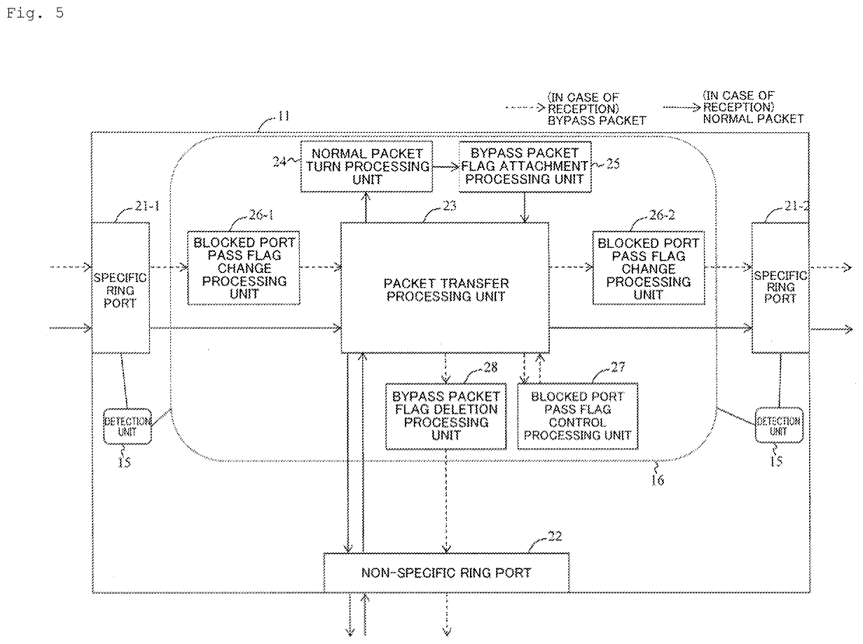

Then, the transfer device 11 that can achieve the route switching method in the ring network described above will be described. FIG. 5 is a functional block diagram illustrating the transfer device 11. The transfer device 11 is a transfer device included in the ring network and includes: a detection unit 15 that detects a non-transferable route through which packet transfer is disabled in the ring network; and a transfer control unit 16 that performs route switching work for setting or releasing a blocked port by communicating with another transfer device in the ring network and performs switching a route of packet to a route that avoids the non-transferable route, in which the transfer control unit 16 has a packet processing function that attaches a bypass packet flag to the packet that passes through the non-transferable route and specifies the packet as a bypass packet when the non-transferable route is detected, a turning function that turns the bypass packet in a direction opposite to that of the packet in the ring network, and a blocked port transfer function that transfers the bypass packet from the blocked port if the blocked port is set when the bypass packet is received before the route switching work.

It should be noted that the packet processing function preferably attaches the blocked port pass flag indicating whether to pass through the blocked port to the bypass packet.

The transfer device 11 will be described in more detail. The transfer device 11 includes specific ring ports (21-1 and 21-2), a non-specific ring port 22, a packet transfer processing unit 23, a normal packet turn processing unit 24, a bypass packet flag attachment processing unit 25, blocked port pass flag change processing units (26-1 and 26-2), a blocked port pass flag control processing unit 27, and a bypass packet flag deletion processing unit 28.

The specific ring ports (21-1 and 21-2) are ports constituting the ring network and transmit and receive packets. The non-specific ring port 22 is the port other than the specific ring ports (21-1 and 21-2) and sends and receives the packet to and from the outside of the ring network. The packet transfer processing unit 23 performs the transfer processing of packets. When the detection unit 15 detects a failure in the ring, the normal packet turn processing unit 24 performs turn processing of packets within the transfer device by using failure information and network information held by the transfer device 11. It is assumed that, for example, when a packet to be transferred from the specific ring port 21-2 to the specific ring port 21-1 or from the non-specific ring port 22 to the specific ring port 21-1 arrives, the link of the specific ring port 21-1 fails and the packet cannot be transferred. The normal packet turn processing unit 24 changes the header of the packet so that the packet is transferred in the opposite direction (output from the specific ring port 21-2) using the retained information.

The bypass packet flag attachment processing unit 25 attaches the bypass packet flag to the packet subjected to the turn processing by the normal packet turn processing unit 24 and converts the packet to an emergency bypass packet that is concluded within the ring. It should be noted that the bypass packet flag attachment processing unit 25 preferably attaches the blocked port pass flag (for example, “0”) too when the attaching the bypass packet flag to the bypass packet.

Here, it is assumed that the specific ring port 21-2 of the transfer device 11 is blocked. When the specific ring port 21-1 receives a bypass packet from the outside, the packet transfer processing unit 23 outputs the packet from the blocked specific ring port 21-2 by using the bypass packet information, and the failure information and the network information held by the transfer device. At this time, the blocked port pass flag change processing unit 26-2 changes (changes the blocked port pass flag from “0” to “1”) the flag indicating that the bypass packet has passed the blocked port when the bypass packet is output from the blocked port.

The blocked port pass flag control processing unit 27 determines the transfer and disposal of the bypass packet based on the blocked port pass flag of the bypass packet to be output from the non-specific ring port 22. For example, the blocked port pass flag control processing unit 27 instructs the packet transfer unit 23 to discard the bypass packet to be output from the non-specific ring port 22 because the blocked port pass flag control processing unit 27 allows the bypass packet with a blocked port pass flag of 0 to be output to the specific ring port (21-1 or 21-2) and disallows the bypass packet to be output from the non-specific ring port 22.

In contrast, the blocked port pass flag control processing unit 27 allows the bypass packet with a blocked port pass flag of 1 to be output to the specific ring port (21-1 or 21-2) and to be output from the non-specific ring port 22. Accordingly, the bypass packet flag deletion processing unit 28 deletes the bypass packet flag and the blocked port pass flag from the bypass packet to be output from the non-specific ring port 22 and restores the packet format thereof to the normal packet format. The non-specific ring port 22 outputs the packet with the packet format restored to the normal packet format.

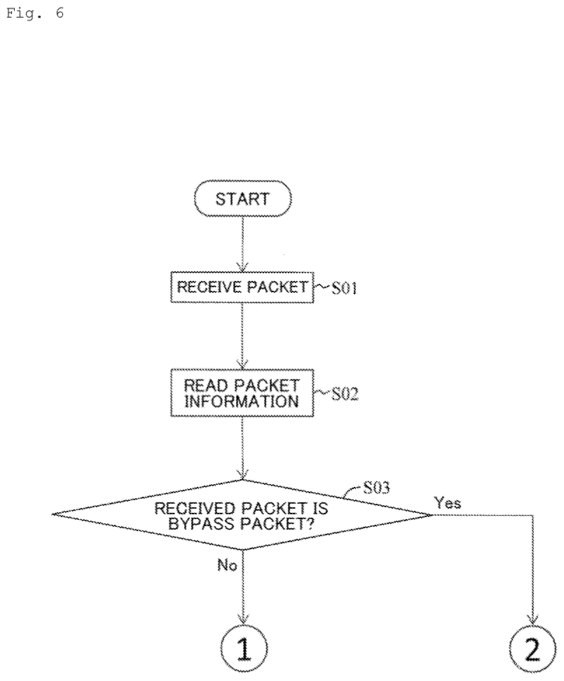

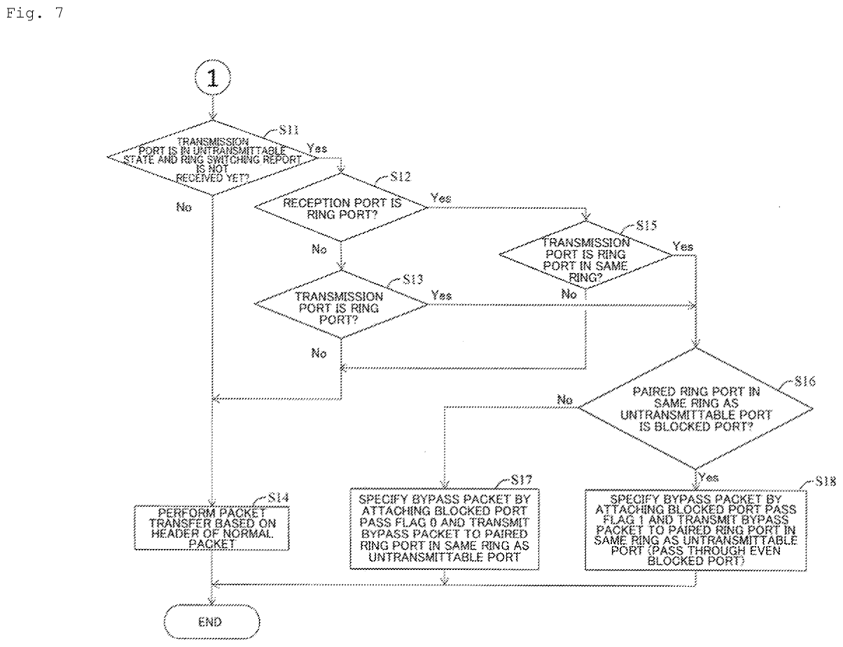

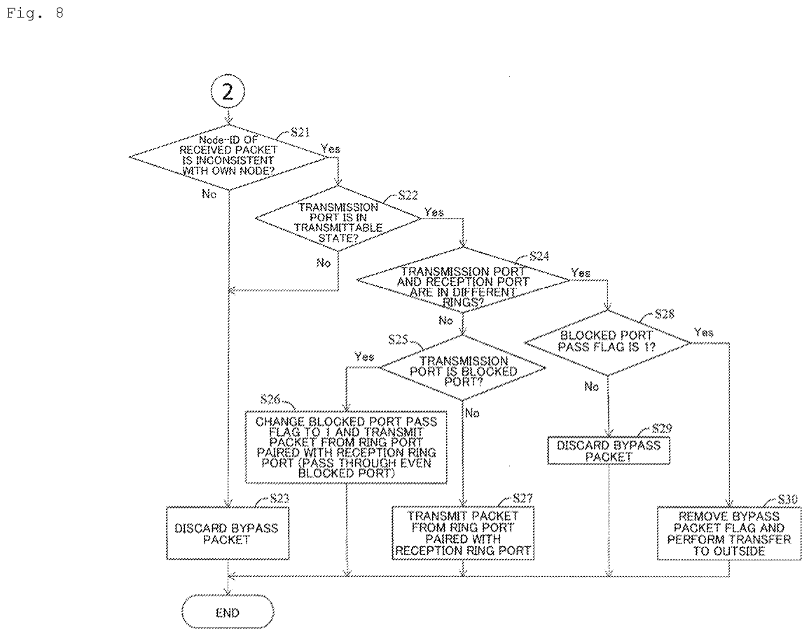

FIGS. 6 to 8 are a flowchart illustrating the operation of the transfer device 11. When receiving a packet (step S01), the transfer device 11 reads the information (presence or absence of the bypass packet flag) of the packet (step S02). When the packet is a normal packet (“No” in step S03), the processing for a normal packet in FIG. 7 is performed. When the packet is a bypass packet (“Yes” in step S03), the processing for the bypass packet in FIG. 8 is performed.

The processing for a normal packet in FIG. 7 will be described.

The packet transfer processing unit 23 determines whether the transmission port that outputs the packet is in a untransmittable state (the transmission destination fails) or ring switching is not performed (ring switching report is not received yet) (step S11). Here, the transmission port includes both the specific ring port 21 and the non-specific ring port 22. In the case of “Yes” in step S11, a check is made as to whether the reception port that has received the packet is the specific ring port 21 (step S12). In the case of “No” in step S12, a check is made as to whether the transmission port that outputs the packet is the specific ring port 21 (step S13). In the case of “No” in step S11 or “No” in step S13, packet transfer based on the header of the packet is performed (step S14).

In the case of “Yes” in step S12, a check is made as to whether the transmission port that outputs the packet and the reception port that has received the packet are the specific ring ports (21-1 and 21-2) in the same ring network (step S15). In the case of “No” in step S15, step S14 is executed. In contrast, in the case of “Yes” in step S13 or “Yes” in step S15, a check is made as to whether the blocked port pass flag is attached (step S16). Specifically, a check is made as to whether the specific ring port in the same ring network as own specific ring port or the specific ring port in a untransmittable state in the transfer destination node is a blocked port. For example, in step S16, when a failure occurs in the link between the node A and the node B in the state as illustrated in the node A in FIG. 2, the specific ring port in a untransmittable state is the port a2 and the specific ring port in the same ring network is a port a1.

In the case of “No” in step S16 (for example, in the case of the node A in FIG. 2(B)), the turn processing is performed. Specifically, the bypass packet flag and the blocked port pass flag (=“0”) are attached to the packet to specify a bypass packet and the packet is transmitted to the specific ring port (port a1) in the same ring network as the specific ring port (port a2) in a untransmittable state (step S17). Step S17 can prevent the double transfer of the packet to the outside of the ring network.

In contrast, in the case of “Yes” in step S16 (for example, when a failure occurs in the link between the node F and the node E in FIG. 2), the bypass packet flag and the blocked port pass flag (=“1”) are attached to the packet to be transferred toward the node F from the outside of the ring network to specify a bypass packet. Then, the packet is transmitted to the specific ring port (port e1) in the same ring network as the specific ring port (port e2) in a untransmittable state (step S18). In this step, the bypass packet passes through the port e1 even if the port e1 is a blocked port. In step S18, the packet can be transferred to the outside of the ring network via a bypass route of the bypass packet.

It should be noted that the blocked port in step S16 also includes the port (the ring protection link end point for which blocking has been released, for example, the port e1 in FIG. 2(D)) that was once blocked. That is, the operation of the processing described above does not change regardless of whether the port which was once the ring protection link end point is in the blocked state (initial state) or in the blocking-released state (after the control packet passes) (the packet is transferred to the adjacent node).

Next, the processing of the bypass packet in FIG. 8 will be described.

The packet transfer processing unit 23 checks whether the bypass packet has made one turn in the ring network (step S21). Specifically, a check is made as to whether the node ID of the header portion of the received bypass packet is inconsistent with that of own node. In the case of “Yes” in step S21, a check is made as to whether the specific ring port that transmits the bypass packet is enabled (step S22). In the case of “No” in step S21 or “No” in step S22, the bypass packet is discarded due to double failure (step S23).

In contrast, in the case of “Yes” in step S22, a check is made as to whether the specific ring port transmits the bypass packet and the specific ring port that receives the bypass packet are present in the same ring network (step S24). In the case of “No” in step S24, a check is made as to whether the specific ring port that transmits the bypass packet is a blocked port (step S25). In the case of “Yes” in step S25, the blocked port pass flag of the bypass packet is changed from “0” to “1” and the bypass packet is transferred from the blocked specific ring port (step S26). In contrast, in the case of “No” in step S25, the blocked port pass flag of the bypass packet is not changed and the bypass packet is transferred from the specific ring port that transmits the bypass packet (step S27).

In the case of “Yes” in step S24, since the packet is transferred to the outside of the ring network, the blocked port pass flag is checked to prevent double transfer (step S28). When the blocked port pass flag is “0” (“No” in step S28), double transfer is assumed, so the bypass packet is discarded (step S29). In contrast, when the blocked port pass flag is “1” (“Yes” in step S28), double transfer is not assumed, so the bypass packet flag is removed and the packet is transferred from the non-specific ring port to the outside of the ring network (step S30).

It should be noted that the blocked port in step S25 also includes the port (the ring protection end point for which blocking has been released, for example, the port e1 in FIG. 2(D)) that was once blocked. That is, the operation of the processing described above does not change regardless of whether the port which was once the ring protection link end point is in the blocked state (initial state) or in the blocking-released state (after the control packet passes) (the packet is transferred to the adjacent node).

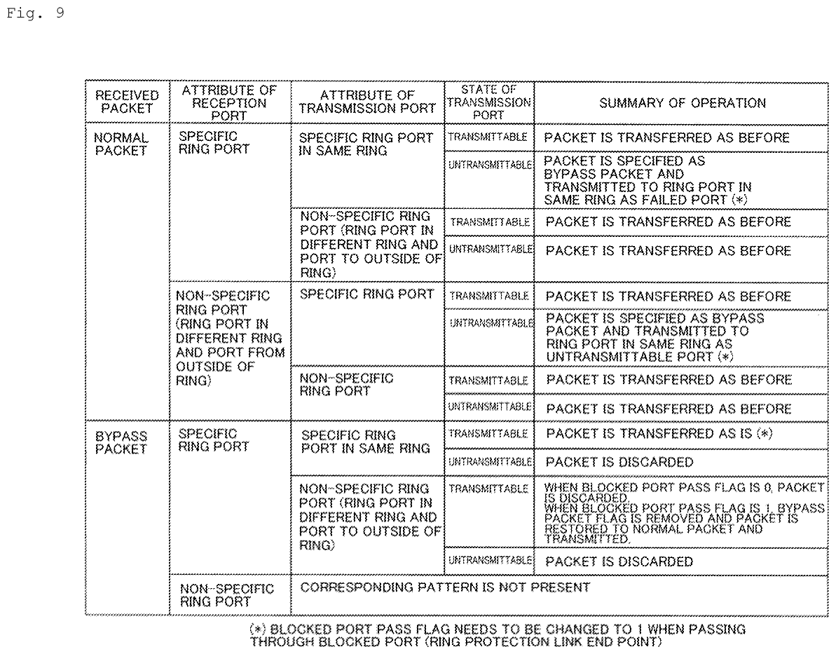

FIG. 9 is a table listing the transfer patterns performed by the transfer device 11 described in the flowchart in FIGS. 6 to 8. It should be noted that the description “PACKET IS TRANSFERRED AS BEFORE” in the table means that the transfer method specified in NPL 1 is followed.

The transfer device 11 reads the received packet and makes a bypass determination in the ring network. The determination depends on the reception packet, the attributes of the transmission and reception ports, and the state of the transmission port as illustrated in the table in FIG. 9. Since the transfer device 11 operates as described above, the following effects are obtained.

As described above, when a failure occurs in the ring network, the communication interruption time due to route switching can be reduced to the time from the occurrence to the detection of the failure by using the bypass packet. In addition, even when route switching in the ring network is performed in a planned manner, the route switching can be performed without causing a communication interruption.

### Embodiment 2

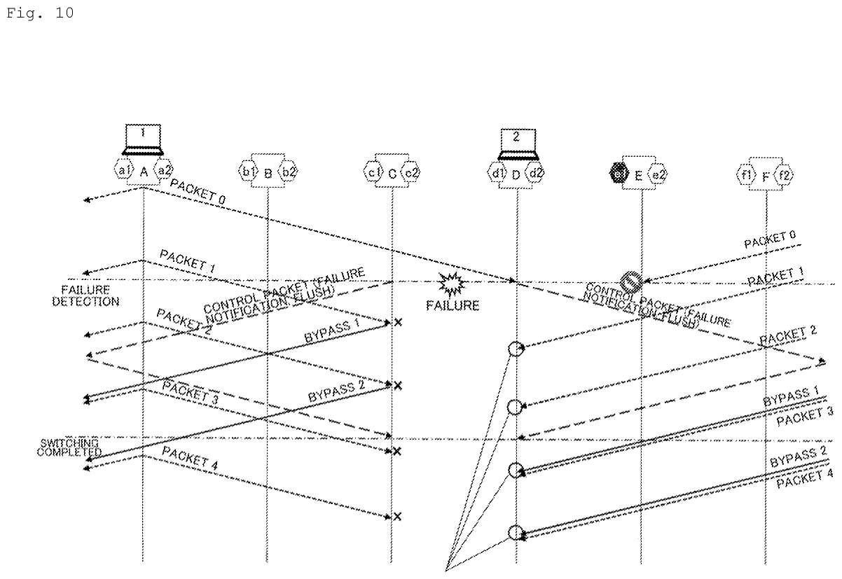

The case in which a multicast packet is transferred in the ring network will be described in the embodiment. FIG. 10 is a figure illustrating the problem with the case in which a multicast packet is transferred via a ring network. It is assumed that six nodes A to F are present and a multicast packet is transmitted from the node A. A port e1 of the node E is blocked at an initial state. In FIG. 10, dashed lines represent a multicast packet transferred from the node A, long dashed lines represent a control packet that reports the occurrence or recovery of a failure between nodes, and solid lines represent a bypass packet obtained by returning the multicast packet at the node (node C in FIG. 10) that has detected a failure.

It is assumed that a failure has occurred in the link between the node C and the node D. In this case, the packet 0 is not affected by the failure and reaches all the nodes. However, the node C blocks a port c2 and the node D blocks a port d1 after the failure is detected by the node C and the node D, so a packet 1 and subsequent packets are returned as bypass packets at the node C.

In contrast, since the packets are multicast packets, the packets are also transferred in the opposite direction in the ring network. The packets 0 that turn in the opposite direction are transferred from the node A to the node E, and the transfer of the packet is stopped at the blocked port e1.

The node C and the node D detect this failure and transmit the control packets in the direction away from the failed link, and the node E releases the blocking of the port e1 by receiving this control packets. Accordingly, the node D can receive the packets that turn in the opposite direction even after the occurrence of the failure. However, the bypass packets returned by the node C also reach the node D in the opposite direction. That is, although the node D has received the packets 1 and 2, the node D also receive these bypass packets 1 and 2, thereby causing packet duplication.

It should be noted that the node C stops transmitting the bypass packet after the control packet transmitted by the node D reaches the node C via the nodes E, F, A, and B, so the packet duplication at the node D is resolved (packet duplication does not occur at the packet 3 and subsequent packets).

When the multicast packet is transferred via the ring network as illustrated in FIG. 10, there is a problem in that packet duplication occurs. Accordingly, the embodiment discloses a route switching method and a transfer device that can avoid packet duplication.

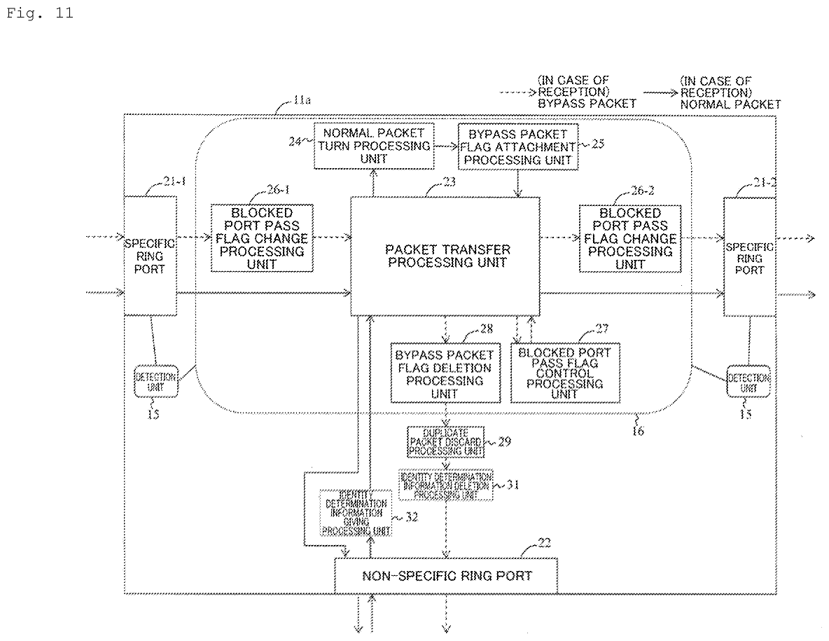

FIG. 11 is a figure illustrating a transfer device 11a according to the embodiment. In addition to the components of the transfer device 11 described in embodiment 1, the transfer device 11a further includes a determination unit that determines whether the packet is identical to a past packet when receiving the packet to be transferred to the outside of the ring network and a discarding unit that discards the packet when the packet is identical to the past packet. Specifically, in addition to the components of the transfer device 11, the transfer device 11a further includes an identity determination information deletion processing unit 31 and an identity determination information giving processing unit 32 as the determination unit and a duplicate packet discard processing unit 29 as the discarding unit.

The duplicate packet discard processing unit 29 determines the duplication between the normal packet and the bypass packet and performs transfer or discarding. The identity determination information giving unit 32 gives information for determining the identity of the packets to the normal packet. The identity determination information deletion processing unit 31 deletes the identity determination information of the packet. The duplicate packet discard processing unit 29 compares the packet to be transferred to the outside of the ring network with the packet transferred to the outside of the ring network in the past using information given by the identity determination information giving unit 32. As a result of the comparison, when the identity determination information is consistent with that of the packet transferred to the outside of the ring network in the past, the duplicate packet discard processing unit 29 determines packet duplication and discards the packet to be transferred to the outside of the ring network. In contrast, when the identity determination information is inconsistent with that of the packet transferred to the outside of the ring network in the past, the duplicate packet discard processing unit 29 does not discard the packet and transfers the packet to the outside of the ring network after the identity determination information deletion processing unit 31 deletes the identity determination information.

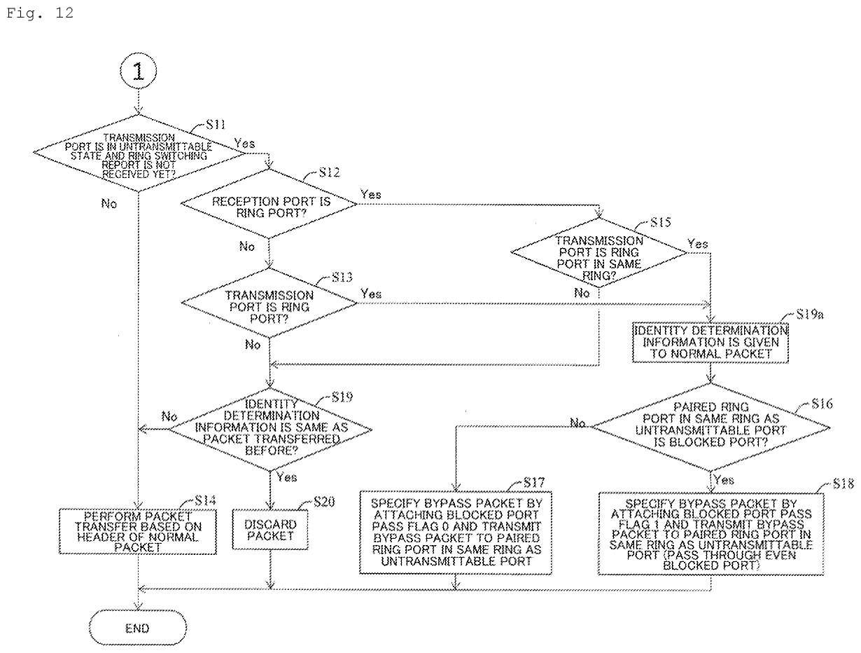

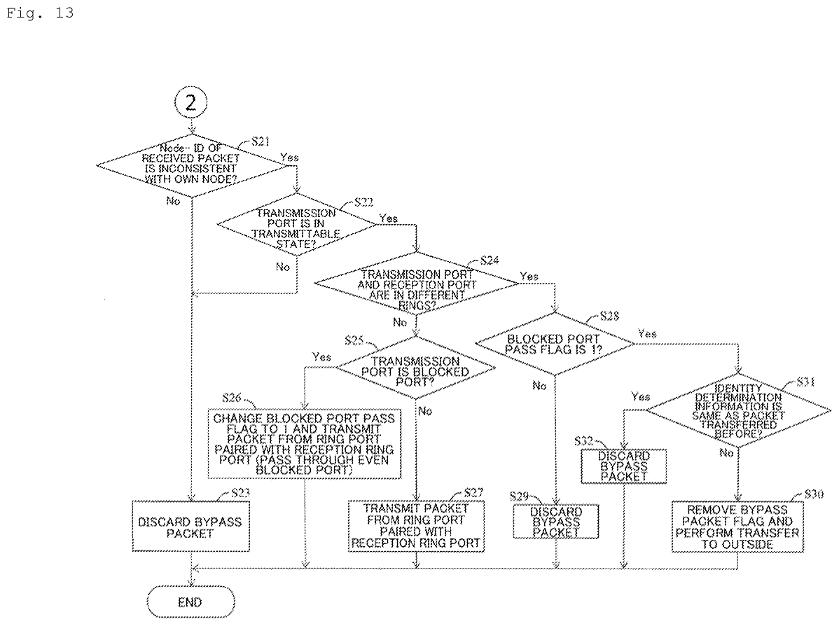

FIG. 6, FIG. 12, and FIG. 13 are a flowchart illustrating the operation of the transfer device 11a. A determination as to whether the received packet is a normal packet or a bypass packet is the same as the operation of the transfer device 11 described in FIG. 6.

The processing of the normal packet in FIG. 12 will be described. Here, only the difference from the processing in FIG. 7 will be described.

In the case of “No” in step S13, the identity determination information of the received packet is compared with that of the past packet (step S19). When the identity determination information of the received packet is different from that of the past packet (“No” in step S19), packet transfer based on the header of the packet is performed (step S14). In contrast, when the identity determination information of the received packet is the same as that of the past packet (“Yes” in step S19), packet duplication has occurred, so the received packet is discarded (step S20). Alternatively, in the case of “Yes” in step S13 or “Yes” in step S15, the identity determination information is added to the normal packet (step S19a) and then step S16 is executed.

The processing of the bypass packet in FIG. 13 will be described. Here, only the difference from the processing in FIG. 8 will be described.

When the blocked port pass flag is “1” (“Yes” in step S28), the identity determination information of the received bypass packet is compared with that of the past packet (step S31). When the identity determination information of the received bypass packet is consistent with that of the past packet (“Yes” in step S31), the received bypass packet is discarded to prevent packet duplication (step S32). In contrast, when the identity determination information of the received bypass packet is inconsistent with that of the past packet (“No” in step S31), step S30 is executed.

The transfer device 11a according to the embodiment adds information for determining the identity of the packet to the normal packet, checks the identity determination information in the transfer devices. Then, when the identity determination information is inconsistent with that of the packet transferred in the past, the transfer device 11a deletes the identity determination information and transfer the packet to the outside of the ring network. When the identity determination information is consistent with that of the packet transferred in the past, the transfer device 11a discards the packet without transferring the packet to the outside of the ring network. The transfer device 11a according to the embodiment can prevent duplication of the same packet caused by delivery of both the normal packet and the bypass packet to the destination.

### Embodiment 3

The case in which a multicast packet is transferred via a ring network will be also described in the embodiment. The problem with the case in which a multicast packet is transferred via the ring network is as illustrated in FIG. 10. In the embodiment, a route switching method and a transfer device that avoid packet duplication in a different way from the embodiment 2 will be disclosed.

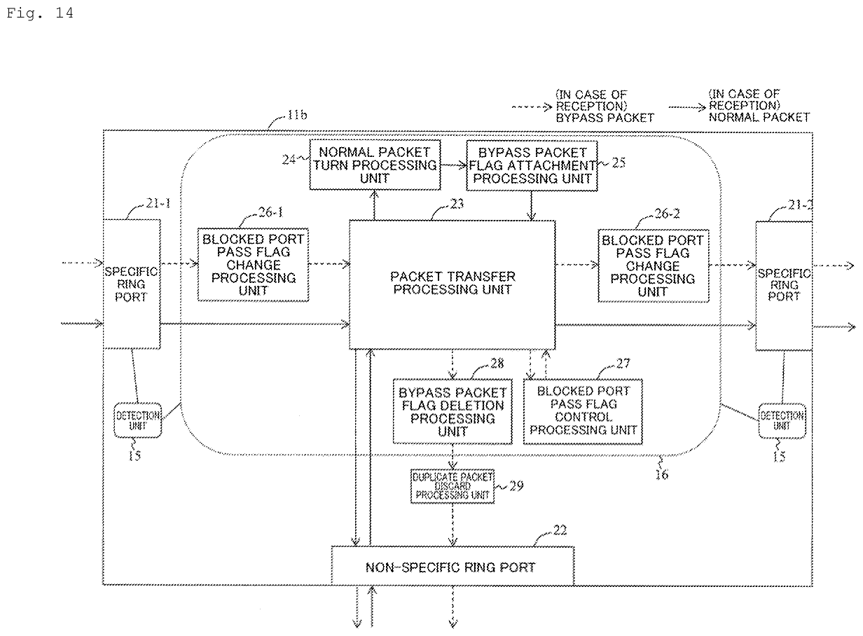

FIG. 14 is a figure illustrating a transfer device 11b according to the embodiment. In addition to the components of the transfer device 11 described in embodiment 1, the transfer device 11b further includes a duplicate packet discard processing unit 29 that determines whether the packet is identical to the past packet when receiving a packet to be transferred to the outside of the ring network and, if the packet is identical to the past packet, discards the packet.

The duplicate packet discard processing unit 29 according to the embodiment also determines the duplication between the normal packet and the bypass packet and then performs transferring or discarding, but is different from the duplicate packet discard processing unit 29 according to the embodiment 2 that makes a determination based on the identity determination information added to the packet. The duplicate packet discard processing unit 29 according to the embodiment performs specific calculation based on packet information and compares the result with the calculation result of the packet transferred to the outside of the ring network in the past. An example of the specific calculation will be indicated.

The CRC (cyclic redundancy check) value of the generating polynomial G(x) below is calculated using, for example, an FCS (frame check sequence, four octets).

G(x)=x³²+x²⁶+x²³+x²²+x¹⁶+x¹²+x¹¹+x¹⁰+x⁸+x⁷+x⁵30 x⁵+x²+x+1

As a result of the comparison, when the calculation result is consistent with the packet transferred to the outside of the ring network in the past, the duplicate packet discard processing unit 29 determines packet duplication and discards the packet to be transferred to the outside of the ring network. In contrast, when the calculation result is inconsistent with the packet transferred to the outside of the ring network in the past, the duplicate packet discard processing unit 29 transfers the packet to the outside of the ring network without discarding the packet.

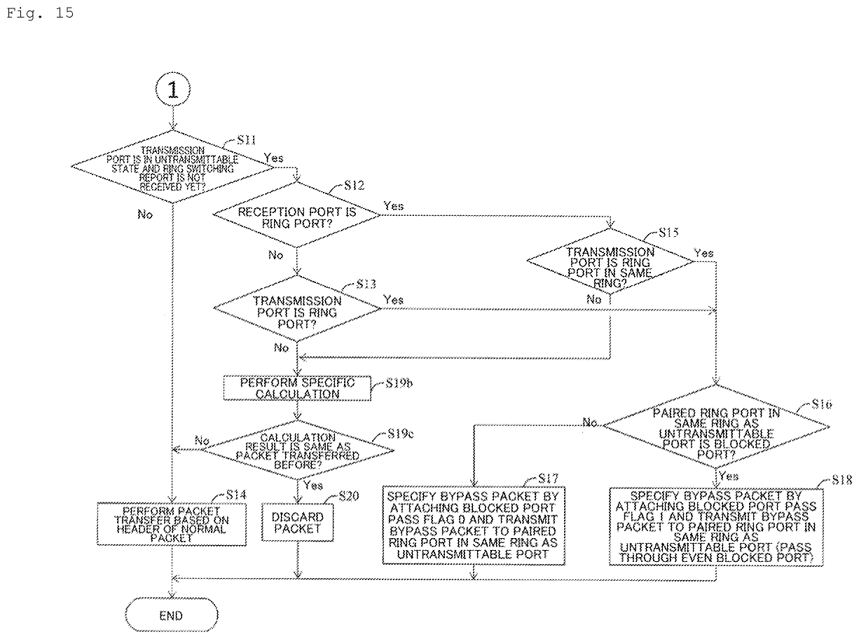

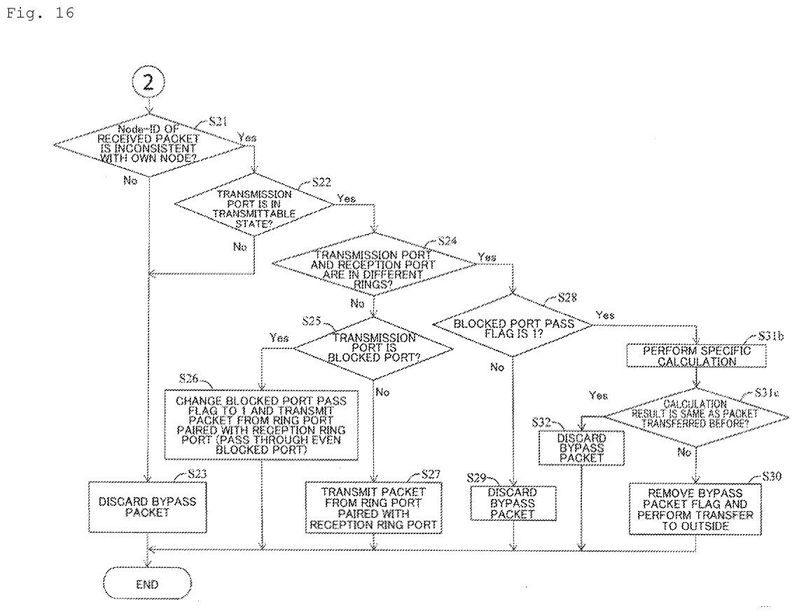

FIG. 6, FIG. 15, and FIG. 16 are a flowchart illustrating the operation of the transfer device 11b. A determination as to whether the received packet is a normal packet or a bypass packet is the same as the operation of the transfer device 11 described in FIG. 6.

The processing of the normal packet in FIG. 15 will be described. Here, only the difference from the processing in FIG. 7 will be described.

In the case of “No” in step S13, the specific calculation as described above is performed (step S19b). Then, the calculation result of the received packet is compared with the calculation result of the past packet (step S19c). When the calculation result of the received packet is different from the calculation result of the past packet (“No” in step S19c), packet transfer based on the header of the packet is performed (step S14). In contrast, when the calculation result of the received packet is the same as that of the past packet (“Yes” in step S19c), the received packet is discarded because packet duplication occurs (step S20).

The processing of the bypass packet in FIG. 16 will be described. Here, only the difference from the processing in FIG. 8 will be described.

When the blocked port pass flag is “1” (“Yes” in step S28), the specific calculation described above is performed on the received bypass packet (step S31b). Then, the calculation result of the received bypass packet is compared with the calculation result of the past packet (step S31c). When the calculated result of the received bypass packet is consistent with the calculated result of the past packet (“Yes” in step S31c), the received bypass packet is discarded because packet duplication occurs (step S32). In contrast, when the calculated result of the received bypass packet is inconsistent with the calculated result of the past packet (“No” in step S31c), step S30 is executed.

The transfer device 11b according to the embodiment performs the specific calculation based on the packet information and compares the calculation result with the calculation result of the packet transferred in the past. The transfer device 11b transfers the packet as it is when the calculation result is inconsistent with the calculation result of the packet transferred in the past or discards the packet when these calculation results are consistent with each other. The transfer device 11b according to the embodiment can prevent duplication of the same packet caused by delivery of both the normal packet and the bypass packet to the destination. Furthermore, the transfer device 11b can prevent duplication without requiring a special header or the like of the packet as compared with the transfer device 11a according to the second embodiment.

### REFERENCE SIGNS LIST

11, 11a, 11b Transfer device
15 Detection unit
16 Transfer control unit
21-1, 21-2 Specific ring port
22 Non-specific ring port
23 Packet transfer processing unit
24 Normal packet turn processing unit
25 Bypass packet flag attachment processing unit
26-1, 26-2 Blocked port pass flag change processing unit
27 Blocked port pass flag control processing unit
28 Bypass packet flag deletion processing unit
29 Duplicate packet discard processing unit
31 Identity determination information deletion processing unit
32 Identity determination information giving processing unit

1. A route switching method in a ring network, the method comprising:
detecting a non-transferable route through which packet transfer is disabled in the ring network;
performing route switching work that changes a position of a blocked port set in a transfer device in the ring network and performs switching to a route that avoids the non-transferable route; and
performing bypass transfer that transfers a packet while bypassing the non-transferable route during the route switching work,
wherein, in the bypass transfer,
the transfer device having detected the non-transferable route attaches a bypass packet flag to a packet that passes through the non-transferable route and specifies the packet as a bypass packet,
the transfer device having detected the non-transferable route returns the bypass packet and transfers the bypass packet in a direction opposite to that of the packet, and
the transfer device for which the blocked port is set in the ring network transfers the bypass packet through the blocked port before the route switching work.

2. The route switching method according to claim 1, wherein a blocked port pass flag indicating whether to pass through the blocked port is attached to the bypass packet.

3. The route switching method according to claim 1, wherein
the transfer device that transfers the packet to an outside of the ring network determines whether the packet is identical to a past packet and, when the packet is identical to the past packet, discards the packet.

4. A transfer device included in a ring network, comprising:
a detection unit configured to detect a non-transferable route through which packet transfer is disabled in the ring network; and
a transfer control unit configured to perform route switching work for setting or releasing a blocked port by communicating with another transfer device in the ring network and performs switching a route of packet to a route that avoids the non-transferable route, wherein
the transfer control unit has a packet processing function that attaches a bypass packet flag to a packet that passes through the non-transferable route and specifies the packet as a bypass packet when the non-transferable route is detected,
a turning function that turns the bypass packet in a direction opposite to that of the packet in the ring network, and
a blocked port transfer function that transfers the bypass packet from the blocked port if the blocked port is set when the bypass packet is received before the route switching work.

5. The transfer device according to claim 4, wherein
the packet processing function attaches a blocked port pass flag indicating whether to pass through the blocked port to the bypass packet.

6. The transfer device according to claim 4, further comprising:
a determination unit configured to determine whether the packet is identical to a past packet when receiving a packet to be transferred to an outside of the ring network; and
a discard unit configured to discard the packet when the packet is identical to the past packet.

7. A communication system for a ring network, comprising:
the transfer device according to claim 4.
